(19) United States
(12) Patent Application Publication
(10) Pub. No.: US 2025/0116485 A1
(43) Pub. Date: Apr. 10, 2025

(54) WEAPON SIGHT

(71) Applicant: EOTech, LLC, Plymouth, MI (US)

(72) Inventors: Waylin Wing, Ann Arbor, MI (US); Joseph Brincat, Livonia, MI (US); Anthony Heath, Plymouth, MI (US); Dean Loebig, Howell, MI (US); Abram Summerfield, Orofino, ID (US)

(21) Appl. No.: 18/908,266

(22) Filed: Oct. 7, 2024

Related U.S. Application Data
(60) Provisional application No. 63/588,538, filed on Oct. 6, 2023.

(51) Int. Cl. F41G 1/30

(52) U.S. Cl. CPC F41G 1/30

(57) ABSTRACT

A weapon sight includes a chassis and an optical system. The chassis is coupleable to a firearm. The optical system is coupled to the chassis and includes a light source, a collimator, a mirror, a diffraction grating, and a hologram. The light source is a light emitting diode (LED) that emits light. The collimator receives the light from the light source and reflects the light in parallel rays. The folding mirror receives the light from the collimator and reflects the light in the parallel rays. The diffraction grating receives the light from the folding mirror and diffracts the light. The hologram receives the light from the diffraction grating to output a reticle visible by a user of the weapon sight.

### CROSS-REFERENCE TO RELATED APPLICATION(S)

This application claims priority to and the benefit of U.S. Provisional Application No. 63/588,538, filed Oct. 6, 2023, the entire disclosure of which is incorporated by reference herein.

### TECHNICAL FIELD

This disclosure relates to weapon sights and, more specifically holographic weapon sights.

### BACKGROUND

Holographic weapon sights utilize holograms to output aiming reticles. Holographic weapon sights may have technical advantages and/or be preferred by users over non-holographic weapon sights, such as “red dot” sights. Holographic weapons sights utilize lasers as light sources for outputting the aiming reticles from holograms. These lasers, however, have high power consumption and may significantly lower battery life as compared to non-holographic weapon sights with other types of light sources with comparably-sized battery power sources. It would be advantageous to provide a holographic weapon sight with a light source having lower power consumption than typical laser light sources.

### SUMMARY

Disclosed herein are implementations of weapon sights. In one implementation, a weapon sight includes a chassis and an optical system. The chassis is coupleable to a firearm. The optical system is coupled to the chassis and includes a light source, a collimator, a mirror, a diffraction grating, and a hologram. The light source is a light emitting diode (LED) that emits light. The collimator receives the light from the light source and reflects the light in parallel rays to form a collimated light beam such that the light source appears at infinity. The mirror receives the collimated light beam from the collimator and reflects the collimated light beam. The diffraction grating receives the collimated light beam from the mirror and diffracts the light. The hologram receives the light from the diffraction grating to output a holographic image of a reticle visible by a user of the weapon sight.

The weapon sight may further include electronics that include one or more of a power source by which power is provided to the LED, an input by which the user provides user inputs for controlling the LED, and circuitry that controls output of the LED according to the user inputs.

The LED may have an emission area of approximately 500 square microns or less from which light is emitted by the LED, or approximately 100 square microns or less. The LED may have a peak wavelength of between 640 nm and 660 nm, and a full width half maximum (FWHM) of approximately 40 nm or less or approximately 15 nanometers or less.

The light may travel along four central segments of an optical path in sequence from the light source to the collimator to the folding mirror to the diffraction grating and to the hologram, and the four central segments may all be within 45 degrees or less from vertical, wherein the hologram outputs light in horizontal rays. The three of the four central segments may be within 30 degrees or less from vertical.

Dispersions of the diffraction grating and the hologram compensate each other, such that the holographic image of the reticle is three MOA or less. The diffraction grating may have an efficiency of 60% or more. The hologram may have another efficiency of 25% or less.

The collimator may be an off-axis parabolic mirror. The collimator may have an efficiency of 95% or more. The emission area of the LED may be located at a focal point of the collimator.

The LED may be aligned with the optical system using active alignment.

The weapon sight may further include another folding mirror. Light may travel along four central segments of an optical path in sequence the other folding mirror to the collimator to the folding mirror to the diffraction grating and to the hologram. The four central segments may all be within 45 degrees or less from vertical. Three of the four central segments may be within 30 degrees or less from vertical. The light may travel along a fifth central segment of the optical path from the light source to the other folding mirror, and the fifth central segment may be within 20 degrees or less from horizontal.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic view of a weapon sight coupled to a firearm.

FIG. 2 is a side view of the weapon sight of FIG. 1

FIG. 3 is a cross-sectional view of the weapon sight of FIG. 1 depicting internal components.

FIG. 4 is a cross-sectional view of the weapon sight of FIG. 1 depicting an optical path.

FIG. 5 is a cross-sectional view of the weapon sight of FIG. 1 further depicting the optical path.

FIG. 6 is a top view of a collimator mirror of the weapon sight of FIG. 1 depicting a parent mirror for reference in dash-dot lines.

FIG. 7 is a side view of the collimator mirror of FIG. 6.

FIG. 8 is another side view of the collimator mirror of FIG. 6.

FIG. 9 is side view of a subassembly of a light source and the collimator.

FIG. 10 is a rear upper view of optical components of the weapon sight in a fixed relation to each other.

FIG. 11 is a front upper view of the optical components of FIG. 10 of the weapon sight.

FIG. 12 is a rear upper view of an assembly of a chassis and the optical components of the weapon sight in the fixed relation.

FIG. 13 is a front upper view of the assembly of FIG. 12.

FIG. 14 is a rear upper view of the chassis of FIG. 11.

FIG. 15 is a front upper view of the chassis of FIG. 11.

FIG. 16 is a cross-sectional view of the assembly of FIG. 12.

FIG. 17 is a cross-sectional view of another weapon sight that is a variation of the weapon sight of FIGS. 1-5 and 10-16.

### DETAILED DESCRIPTION

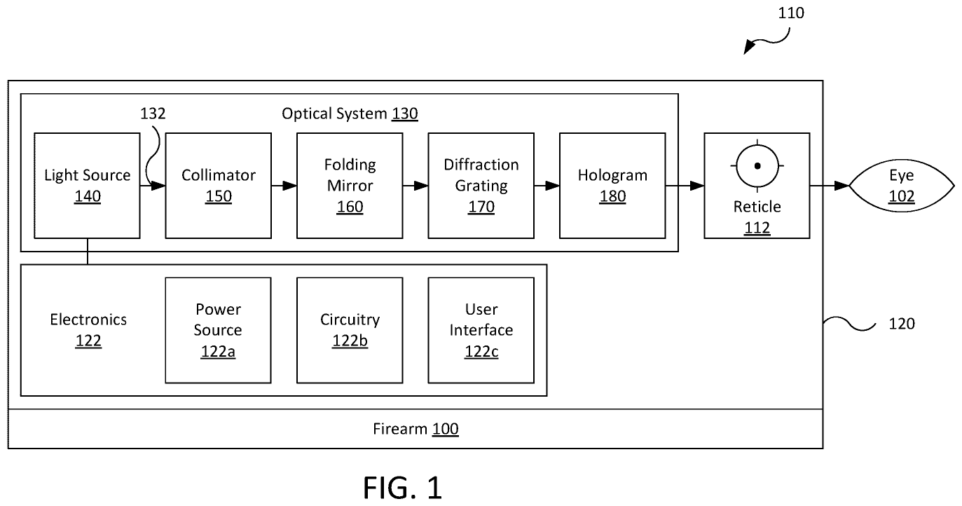

Referring to FIG. 1, a weapon sight 110 is configured to be mounted to a firearm 100 (e.g., a handgun or rifle) and output a reticle 112 to assist a user in aiming the firearm 100. More particularly, the weapon sight 110 is configured to output a reticle 112 that is a holographic image.

The weapon sight 110 generally includes a chassis 120, electronics 122, and an optical system 130. The chassis 120 is configured to couple to the firearm 100, for example, being mountable to a Picatinny rail on the firearm 100 or other mounting configurations. The chassis 120 is coupled to the optical system 130 and may, for example, contain various components of the optical system 130 generally therein and, in turn, is mountable to the firearm 100 to support the optical system 130 thereon.

The optical system 130 is configured to output the reticle 112. The optical system generally includes a light source 140, a collimator 150, a folding mirror 160, a diffraction grating 170, and a hologram 180. The light source 140 emits light that travels along an optical path 132 (represented by arrows in FIG. 1) sequentially from the light source 140 to the collimator 150, the folding mirror 160, the diffraction grating 170, and the hologram 180. The optical system 130 and components thereof are discussed in further detail below.

The weapon sight 110 further includes electronics 122 for operating the weapon sight 110 and, in particular, the light source 140. The electronics 122 may include a power source 122a, circuitry 122b, and a user input 122c. The power source 122a may, for example, be a battery, such as a primary or secondary battery having a standard format, such as CR123 or CR2302. The circuitry 122b is configured to operate the light source 140, for example, conditioning or otherwise supplying the power output by the power source 122a to the light source 140 and/or changing various functions (e.g., on/off, brightness) according to the user input 122c. The user input 122c is configured to receive inputs from the user according to which the optical system 130 is operated, for example, turning on or off the light source 140, controlling brightness output by the light source 140, or both.

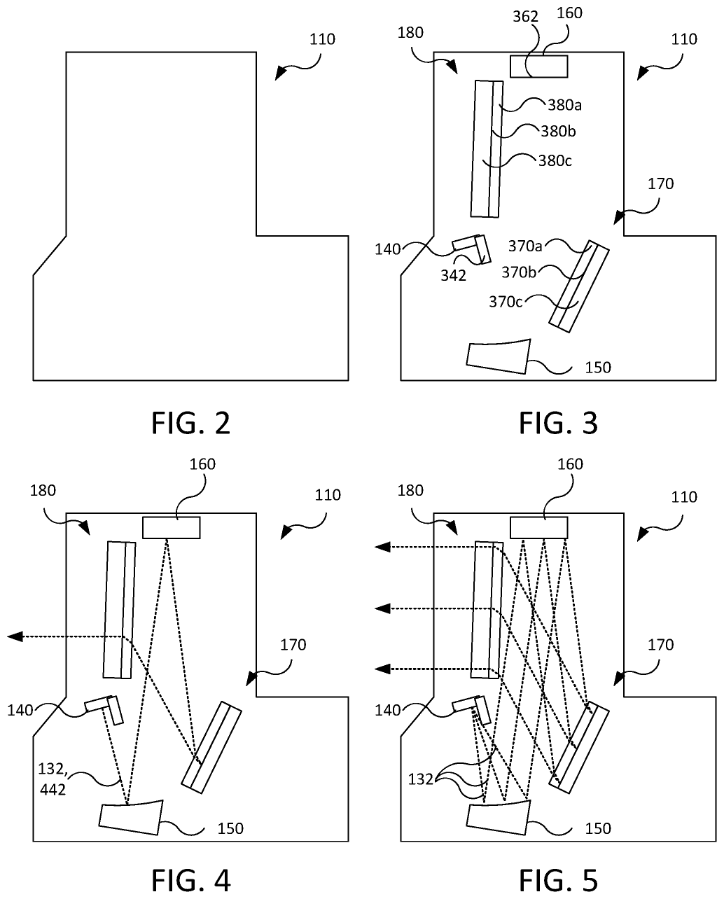

Referring to FIGS. 2-5, the light source 140 is a light emitting diode (LED). As compared to a light source that is a laser (e.g., a laser diode), the light emitted by the LED of the light source 140 may have lower power consumption, lower emission intensity, greater spectral width, and a wider emission angle. For example, if using the same battery (e.g., CR123 with 1500 mAh capacity), the weapon sight 110 having an LED as the light source 140 may have greater than ten times, fifteen times, or more battery life than another weapon sight having a laser diode as a light source for a similar brightness level of the reticle 112 (e.g., 40,000 hours or more vs. 2,500 hours). Thus, as compared to another weapon sight having a laser as a light source, the weapon sight 110 provides the advantage of significantly extended battery life. However, in order to achieve output the reticle 112 with substantially equivalent quantitative and/or qualitative characteristics, the components and arrangement of the optical system 130 in the optical path 132 are different to account for the different light characteristics (e.g., lower emission intensity, greater spectral width, and wider emission) of the light emitted by the LED of the light source 140.

As referenced above, the light output by the LED of the light source 140 follows the optical path 132, in sequence, from the light source 140 to the collimator 150, the folding mirror 160, the diffraction grating 170, and the hologram 180 to the eye 102 of the user.

The light source 140 emits light with a peak wavelength of between approximately or substantially 640 nm and 660 nm, for example, approximately or substantially 650 nm, or other suitable wavelength. The peak wavelength is the wavelength at which light emitted from the light source 140 has maximum intensity. The peak wavelength may vary with temperature, for example, ranging from 653 nm to 656 nm over a temperature range of 25 to 75 degrees Celsius. The peak wavelength may also be referred to as a nominal wavelength. In another example, the light source 140 emits light with a peak wavelength of between approximately or substantially 510 nm and 530 nm, for example, approximately or substantially 520 nm. As used herein, the term “approximately” means+/−2.5% of wavelength raw values (e.g., 650 nm+/−16 nm), +/−10% for spectral width values (e.g., 40 nm+/−4 nm), +/−10% of linear and area dimensional values (e.g., 10 microns+/−1 micron), +/−2 degrees of angular values (e.g., 45 deg+/−2 degrees), and +/−2% of percentage values (e.g., 45%+/−2%). As used herein, the term “substantially” means half that of “approximately” (e.g., +/−1.25% of wavelength values).

The light source 140 may have a spectral width with a full width half maximum (FWHM) of less than approximately 50 nm, such as less than approximately 40, 30, 20, or 15 nanometers (e.g., approximately 12 nanometers). FWHM, or FWHM spectral width, generally refers to the total range of the spectral width in which light emitted by the light source 140 is at least 50% of the maximum intensity (i.e., at the peak wavelength). The FWHM may or may not be centered about the peak wavelength, may vary with the peak wavelength, or both.

The light source 140 may have an emission area from which light is emitted of less than approximately 1,000 square microns, for example, 500, 200, 100 square microns or less. For example, the emission area may have a diameter of 40, 30, 20, or 10 microns or less (e.g., approximately equal to 10 microns).

The light source 140 may be considered to have peak axis 442, which is that axis originating from the emission area and extending through that point or region at which the light emitted by the light source 140 is at maximum intensity. The light source 140 may have an angle of half intensity of between approximately 20 and 70 degrees, such as between 30 and 60 degrees, between 40 and 50 degrees, as such as approximately 45 degrees. The angle of half intensity is that angle between the peak axis 442 and where the intensity of light emitted is half the peak intensity. The angle of half intensity may be generally rotationally symmetric, such that the angle of half intensity forms a generally right circular cone, with the peak axis 442 of the light source 140 extending from the peak through the center of the conical shape and the angle of half intensity extending from the peak and forming the curved sides of the conical shape.

The light source 140 and the collimator 150 are cooperatively configured for the collimator 150 to collect light emitted by the light source 140 and reflect the light in parallel rays (i.e., collimating the light). The light reflected by the collimator 150, being in parallel rays, may be referred to as collimated light or a collimated light beam. The collimator 150 may, for example, be a parabolic mirror, such as an off-axis parabolic mirror. The collimator 150 may also be referred to as a collimator mirror, parabolic mirror, or off-axis parabolic mirror.

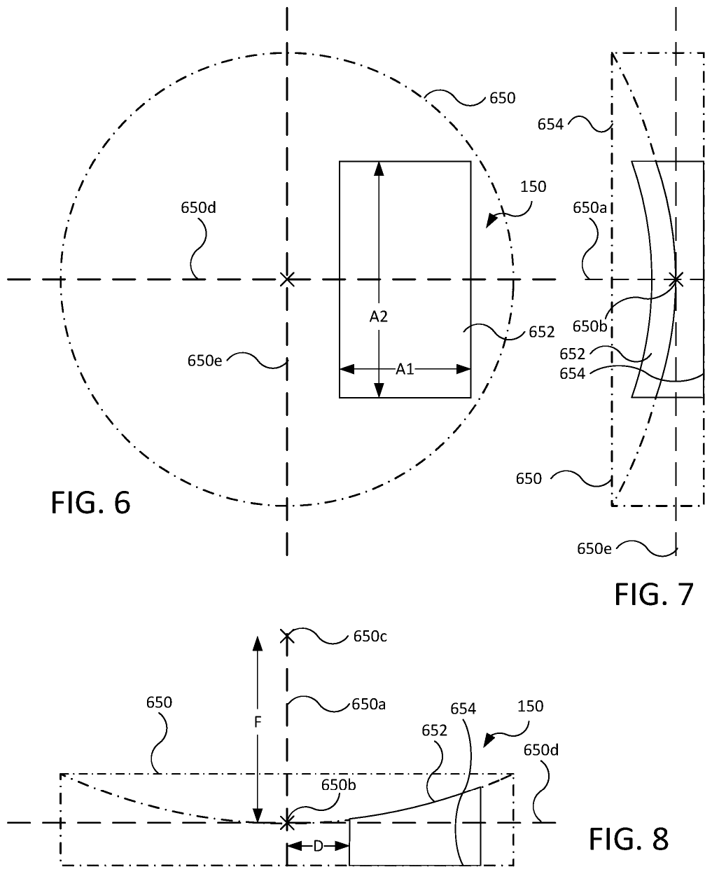

Referring to FIGS. 6-8, the collimator 150 generally includes a first surface 652 and a second surface 654 opposite the first surface 652. The first surface 652 is a reflective surface configured to reflect the light received from the light source 140. The first surface 652 may have reflectance of approximately 95%, 98%, 99%, or more (e.g., approximately 99.5%) of the light emitted by the light source 140 and incident on (e.g., received by) the first surface 652 of the collimator 150 (e.g., at the peak bandwidth at varying temperatures, or a portion of the spectral bandwidth therearound, such as the FWHM spectral width or portion thereof), for example, by having a suitable surface finish and/or reflective coating.

Various dimensional characteristics of the collimator 150 may be defined relative to a parent mirror 650. The collimator 150 may be cut from a parent mirror 650 or may be formed independent thereof while characteristics of the collimator 150 may be defined relative thereto.

The first surface 652 of the collimator 150 is curved. As referenced above, the collimator 150 may be an off-axis parabolic mirror, such that the first surface 652 is concave with a parabolic shape (e.g., forming a portion of a paraboloid). The curvature of the first surface 652 may, for example, provide a parent focal length of approximately 50 mm or less, such as approximately 38 mm, 25 mm, 20 mm, or less (e.g., approximately 10-20 mm, such as approximately 15-18 mm (e.g., 16.7 mm)). It is noted that the parent focal length F is measured along the optical axis 650a of the parent mirror 650 from the optical vertex 650b to a focal point 650c. With the collimator 150 being an off-axis parabolic mirror, the optical axis 650a, the optical vertex 650b, and the focal point 650c are offset from an edge of the collimator 150 by an offset distance D.

The second surface 654 may be planar, which may assist in orienting the collimator 650, or a subassembly of the light source 140 and the collimator 150, to other optical components of the optical system 130, the chassis 120, or both. The second surface 654 may, for example, be perpendicular to the collimated light reflected by the first surface 652.

The aperture of the collimator 150 may be defined in first and second dimensions (e.g., first and second axes, such as X- and Y-axes), which are perpendicular to and intersect each other and the optical axis 650a of the collimator 150 at the optical vertex 650b. The aperture (or width) in the first dimension (i.e., along the first axis 650d), which may be referred to as the first aperture A1 is offset from the optical axis 650a and the second axis 650e by the offset distance D. The offset distance D may, for example, be between 0 and 10 mm, such as between 1 and 5 mm (e.g., between 2 and 3 mm, such as approximately 2.5 mm). The first aperture A1 may, for example, be 50 mm or less, such as less than 35 mm, 15 mm, 10 mm or less (e.g., approximately 9.5 mm). The aperture (or width) of the second dimension, which may be referred to as the second aperture A2, may, for example, be 100 mm or less, such as less than approximately 75 mm, 50 mm, 40 mm, 30 mm, or less (e.g., approximately 29.5 mm). While depicted as being rectilinear in cross-section, the collimator 150 may have any other suitable cross-sectional shape.

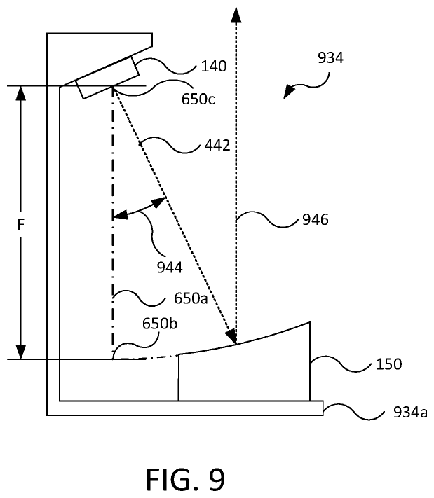

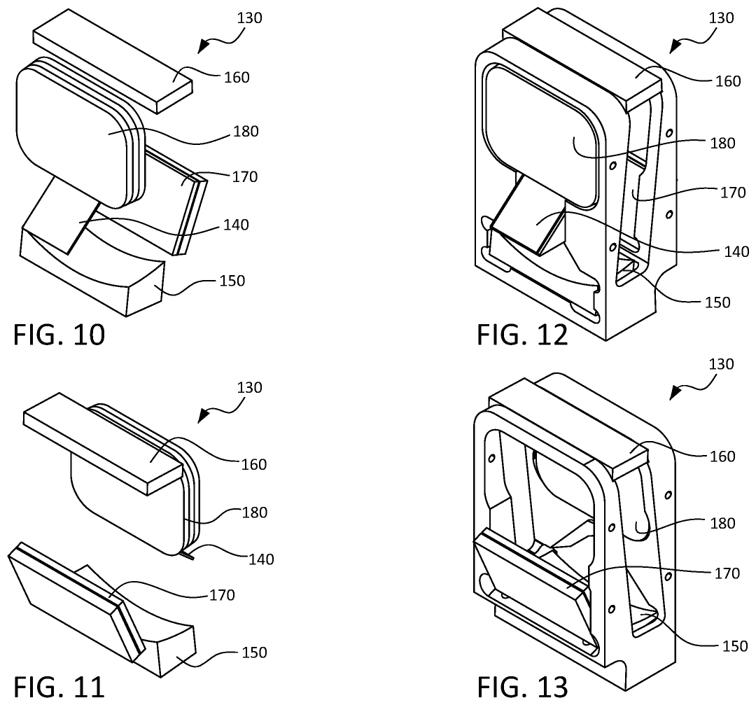

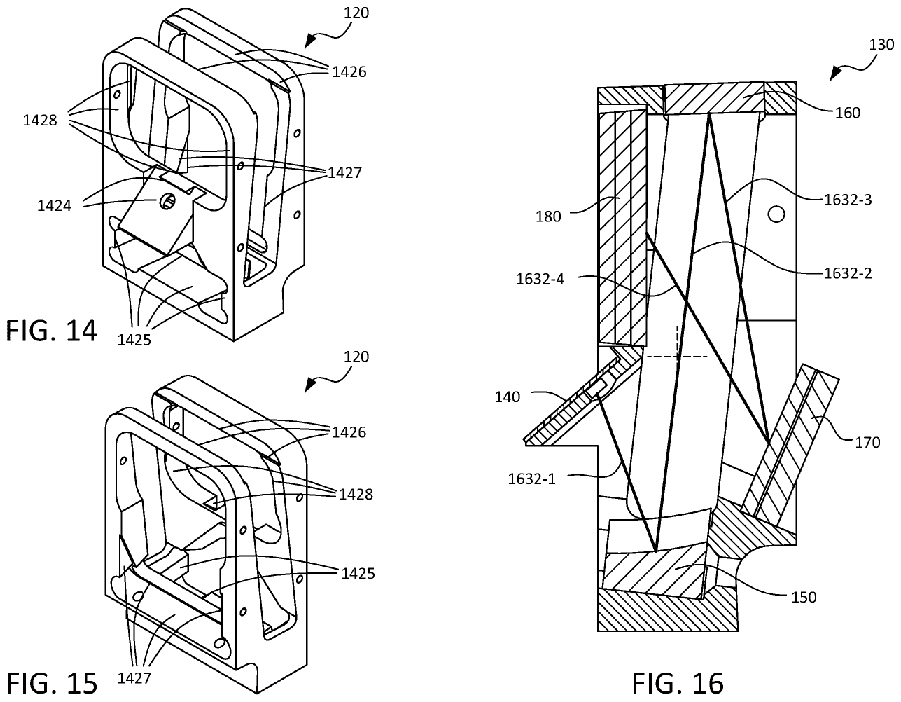

Referring to FIGS. 9 and 10-16, the light source 140 and the collimator 150 are coupled to each other in fixed relation, for example, as a subassembly 934 that is then coupled to the chassis 120 (as shown in FIG. 9) or being coupled independently to the chassis 120 (as shown in FIGS. 10-16).

As further illustrated in FIG. 9, in the fixed relation (whether in the subassembly 934 or being independently coupled to the chassis 120), the light source 140 and the collimator 150 are positioned relative to each other such that the emission area of the light source 140 is located approximately or substantially at the focal point 650c of the collimator 150, for example, along the optical axis 650a a distance equal to the focal length F from the optical vertex 650b. The emission area may also be referred to as an emission surface.

Also in the fixed relation, the light source 140 and the collimator 150 are further oriented relative to each other such that the peak axis 442 of the light emitted by the light source 140 is incident on the collimator 150, for example, at a central region thereof (e.g., within a middle 50%, 25%, 10%, or 5% or less of each of the first aperture A1 and the second aperture A2, such as at midpoints thereof). For example, the light source 140 may be oriented relative to the collimator 150 such that an angle 944 between the peak axis 142 of the light source 140 and the optical axis 650a of the collimator 150 (or the rays of light reflected by the collimator 150), which may be referred to as a central ray angle 946, is between approximately 5 and 45 degrees (e.g., approximately 10-40 degrees, 15-35 degrees, 20-30 degrees, 22-27 degrees, such as approximately 24 degrees).

Referring again to FIGS. 3-5, the folding mirror 160 is configured to receive and reflect light from the collimator 150. More particularly, the folding mirror 160 is configured to reflect the collimated light beam received from the collimator 150 and maintain the light in collimated form (i.e., maintaining the rays of the light in parallel). The light reflected by the folding mirror 160 may be referred to as collimated light, a collimated light beam, reflected collimated light, or a reflected collimated light beam). The folding mirror 160, for example, has a first surface that is reflective and is planar. The first surface 362 may have reflectance of approximately 95%, 98%, 99%, or more (e.g., approximately 99.5%) of the light emitted by the light source 140 and incident on (e.g., received by) reflected by the first surface of the collimator 150 (e.g., at the peak bandwidth at varying temperatures, or a portion of the spectral bandwidth therearound, such as the FWHM spectral width or portion thereof), for example, having a suitable surface finish and/or reflective coating. The area of the first surface 362 of the folding mirror 160 is suitable for receiving and reflecting substantially all light (e.g., 90%, 95%, 97%, 98%, or more) reflected by first surface 652 of the collimator 150, for example, having a surface area approximately equal to that of the first surface 652 of the collimator (e.g., accounting for differences due to the curvature of the first surface 652, for example, being within 20%, 10% or less of thereof).

Referring still to FIGS. 3-5, the diffraction grating 170 and the hologram 180 are cooperatively configured to account for the relatively large FWHM spectral distribution of the light emitted by the light source 140 to output the reticle of suitable resolution (e.g., six, three, or one MOA). For example, dispersions of the diffraction grating 170 and the hologram 180 are configured to compensate each other (e.g., being opposite and slightly unequal value). If the hologram 180 were to receive the collimated beam of light directly from the collimator 150 or the folding mirror 160, the holographic image would appear blurry due to the relatively large FWHM of the light output by the light source 140. This use of the diffraction grating 170 (i.e., to account for a relatively large FWHM to provide holographic image resolution) is different in principle for the present weapon sight 110 with a light source 140 that is an LED from that of laser-based holographic weapon sights. In the laser-based holographic weapon sights, a diffraction grating is instead used to account for positional drift of the holographic reticle image (not image resolution) that would otherwise result from shifting peak bandwidth due to temperature changes (see U.S. Pat. No. 6,490,060 for laser-based holographic weapon sight).

Each of the diffraction grating 170 and the hologram 180 have relatively high efficiency. The diffraction grating 170 is a reflection grating that may, for example, be a volume phase holographic grating having a cover glass 370a, a back glass 370c, and a recording material 370b therebetween. The diffraction grating 170 may have high efficiency, for example, by diffracting or transmitting 60%, 70%, 75%, 80%, 85%, 90% or more of the light received thereby (e.g., the reflected collimated beam from the folding mirror 160 and at the peak bandwidth at varying temperatures, or a portion of the spectral bandwidth therearound, such as the FWHM spectral width or portion thereof) to the hologram 180.

The hologram 180 is a transmission hologram and may, for example, be a volume phase hologram having a cover glass 380a, a back glass 380c, and a recording material 380b therebetween. The hologram 180 may have efficiency of approximately 25%, 20%, 15%, 10%, or lower, which may provide a desired resolution, such as one MOA. The collimator 150, the folding mirror 160, and the diffraction grating 170 may have relatively high efficiency compared to the hologram 180 in order to capture and utilize more of the light emitted by the light source 140, which may not be required for laser-based holographic weapon sights. For example, the diffraction grating 180 may have two, three, four, five times, or more efficiency than the hologram 170.

Referring again to FIGS. 3-5 and 10-16, the components of the optical system 130 are arranged in a horizontally compact manner with horizontal being parallel with the light being emitted by the hologram 180 to the user. For example, as shown in FIG. 16, those four central segments 1632-1, 1632-2, 1632-3, 1632-4 extending along the optical path 132 and between the centers of those surfaces of the optical components of the optical system 130 that receive or transmit light (e.g., emission area of the light source 140, the first surface 152 of the collimator 150, the first surface of the folding mirror 160, the exposed surface of the cover glass 370a of the diffraction grating 170, and the exposed surface of the cover glass 380a of the hologram 180) are all within 45, 40, 35, or 30 degrees or less from vertical. For example, three of the four central segments, such as the central segments 1632-1, 1632-2, 1632-3, may be within 35, 30, or 25 degrees or less from vertical, while another of the four central segments (e.g., the central segment 1632-4 between the diffraction grating 170 and the hologram 180) may be within 45, 40, or 35 degrees or less from vertical.

As illustrated in FIGS. 3-5 and 10-16, the light source 140 is located generally vertically between the hologram 180 and the collimator 150, for example, below the hologram 180 and above the collimator 150 such that different lines within 15 or 10 degrees or less from vertical pass through the emission area of the light source 140 and the hologram 180 or first surface 652 of the collimator 150. The light source 140, such as the emission area or other portion thereof (e.g., a circuit board), may extend rearward (i.e., toward the user) more than one or all the other optical components of the optical system 130 (i.e., rearward of the collimator 150, the folding mirror 160, the diffraction grating 170, and/or the hologram 180). The light source 140 is also positioned rearward of any direct paths along which light passes from the collimator 150 to the folding mirror 160, so as to not interfere therewith.

The collimator 150 is located generally vertically below the light source 140 (as described above), as well as below the folding mirror 160, for example, such that a vertical line (or generally vertical line within 15, 10, or fewer degrees from vertical) passes through both the collimator 150 and the folding mirror 160. The collimator 150 (e.g., the first surface 652, the second surface 654, or both) may extend lower more than one or all the other optical components of the optical system 130 (i.e., below the light source 140, the folding mirror 160, the diffraction grating 170, and/or the hologram 180, such as below the functional surfaces or media thereof that receive and/or process light, other structural aspects thereof, or both).

The folding mirror 160 is positioned above the collimator 150 (as described above) and is also above the diffraction grating 170, for example, such that a vertical line (or generally vertical line within 15, 10, or fewer degrees from vertical) passes through the folding mirror 160 and the diffraction grating 170. The folding mirror 160 (e.g., the reflective surface thereof) may extend higher more than one or all the other optical components of the optical system 130 (i.e., above the light source 140, the collimator 150, the diffraction grating 170, and/or the hologram 180), such as above the functional surfaces thereof that receive and/or process light, other structural aspects thereof, or both.

The diffraction grating 170 is positioned below the folding mirror 160 (as described above). The diffraction grating 170 (e.g., the functional surfaces or media thereof) may extend forward (i.e., away from the user) more than one or all the other optical components of the optical system 130 (i.e., forward of the light source 140, the collimator 150, the folding mirror 160, and/or the hologram 180), such as forward of the functional surfaces or media thereof that receive and/or process light, other structural aspects thereof, or both. The diffraction grating 170 and the light source 140, such as the emission area and/or another portion (e.g., the circuit board) may overlap in elevation, such that a horizontal line passes through both such optical components.

The hologram 180 is positioned above the collimator 150 (as described above) and may also be positioned above the collimator 150, such that a vertical line (or generally vertical line within 15, 10, or fewer degrees from vertical) passes through both the hologram 180 and the collimator 150. The hologram 180 (e.g., the functional surfaces or media thereof) is positioned rearward of (i.e., toward the user) any direct path along which light may pass from the collimator 150 to the folding mirror 160 (e.g., to not block or otherwise interfere with the collimated beam otherwise passing from the collimator 150 to the folding mirror 160).

Moreover, referring to FIG. 3, the weapon sight 110 may include a baffle 342 arranged between the light source 140 (i.e., the emission area thereof) and the diffraction grating 170, such that light cannot pass directly from the light source 140 to the diffraction grating 170. The baffle 342 may, for example, be configured as an opaque member that is coupled to the chassis 120 and arranged between the light source 140 and the diffraction grating 170 but rearward of any direct paths along which light may pass from the collimator 150 to the folding mirror 160 and from the folding mirror 160 to the diffraction grating 170.

As illustrated in FIG. 9 and referenced above, the light source 140 and the collimator 150 may be coupled to each other for form a subassembly 934, which is in turn coupled to the chassis 120. More particularly, each of the light source 140 and the collimator 150 are individually coupled to a sub-chassis 934a that together form the subassembly 934. The sub-chassis 934a is a generally rigid structure formed of one or more components. The sub-chassis 934a is configured to couple to the chassis 120, which may include cooperative alignment features such that the sub-chassis 934a and, thereby, the light source 140 and the collimator 150 are properly positioned and oriented relative to the other components of the optical system 130. Further discussion of the light source 140 and the collimator 150 into the optical system are discussed in further detail below.

Alternatively, as shown in FIGS. 10-15, the light source 140 and the collimator 150 are independently fixedly coupled to the chassis 120 to which the other optical components of the folding mirror 160, the diffraction grating 170, and the hologram 180 are fixedly coupled (e.g., independently fixedly coupled thereto). The chassis 120 may be or include a singular structural component (e.g., monolithic) formed, for example, via injection molding and/or machining to which one or more of the optical components (e.g., all) are directly coupled (e.g., adhered to) or to which a subportion of the optical components (e.g., less than all) are indirectly coupled (e.g., in the subassembly 934 via the sub-chassis 934a). The singular structural component may be formed from any suitable material via any suitable process, for example, by injection or otherwise molding a polymer or composite and/or via machining. The chassis 120 may be positioned within and coupled to a housing (e.g., shaped as shown in FIG. 2).

The chassis 120 is a generally rigid structure formed of one or more components that generally form rectangular cuboid shape having an upper portion, a lower portion, a left portion, a right portion, a forward portion, and a rearward portion. The portions of the chassis 120 define a central aperture 1032 through which the user views the reticle 112 output by the hologram 180 and a target overlaid by the reticle 112.

The chassis 120 defines mounting locations for each of the optical components, including the light source 140, the collimator 150, folding mirror 160, the diffraction grating 170, and the hologram 180. In the case of the subassembly 934 of the light source 140 and the collimator 150, the chassis 120 defines a mounting location for the subassembly 934. The chassis 120 may further include locating features that function to locate and orient the optical components in the mounting locations relative to the chassis 120 and, thereby, relative to each other in the manners described above. Each of the locating features constrain movement of the associated optical component to aid in manufacturing, for example, as the optical components are coupled (e.g., fastened and/or adhered) to the chassis 120.

The chassis 120 may include light source locating features 1424 that generally include a flat surface against which the circuit board of the light source 140 is positioned and coupled, an upper protrusion extending above the flat surface that constrains forward movement of the light source 140, and left and right protrusions extending above the flat surface that constrain left and right movement of the light source).

It is noted, however, the light source 140 may be coupled to the chassis 120 or the sub-chassis 934a using active alignment, whereby the light source 140 emits light and the output thereof is measured (e.g., as reflected off the collimator 150 and/or through the hologram 180), while the position and/or orientation of the light source 140 is adjusted until a desired output is measured at which point the light source 140 is permanently affixed (e.g., adhered) to the chassis 120 or the sub-chassis 934a. In the case of active alignment, the flat surface may be provided for coupling the light source 140 to the chassis 120, while the other location features are not required. The light source locating features 1424 may generally be formed in the rearward portion of the chassis 120 and protrude rearward from surrounding portions of the chassis 120. After being coupled to the chassis 120 (e.g., with fasteners and/or adhesive), the light source 140 remains in a fixed location and orientation relative to the chassis 120.

The chassis 120 may include collimator locating features 1425 that generally define a recess into which the collimator 150 is inserted. The collimator locating features 1425 function to locate and orient the collimator 150 relative to the chassis 120 and, thereby, relative to the other optical components of the optical system 130. The collimator locating features 1425 may, for example include a lower surface that generally constrains downward movement, left and right surfaces that generally constrain lateral movement, and a forward surface that generally constrains forward movement. The collimator locating features 1425 may generally be formed in the lower portion of the chassis 120. After being coupled to the chassis 120 (e.g., with fasteners and/or adhesive), the collimator 150 remains in a fixed location and orientation relative to the chassis 120.

The chassis 120 may include mirror locating features 1426 that generally define a slot into which the folding mirror 160 is inserted. The mirror locating features 1426 function to locate and orient the folding mirror 160 relative to the chassis 120 and, thereby, relative to the other optical components of the optical system 130. The mirror locating features 1426 may, for example include forward and rearward surfaces that generally constrain forward and rearward movement, and lower surfaces (e.g., ledges) adjacent the forward and rearward surfaces that generally constrain downward movement. The mirror locating features 1426 may generally be formed in the upper portion of the chassis 120. After being coupled to the chassis 120 (e.g., with fasteners and/or adhesive), the folding mirror 160 remains in a fixed location and orientation relative to the chassis 120.

The chassis 120 may include grating locating features 1427 that generally define a slot into which the diffraction grating 170 is inserted. The slot, or recess, is arranged on a first side of the chassis, such as a forward side, and is configured to receive the grating 170 through the first side. The grating locating features 1427 function to locate and orient the diffraction grating 170 relative to the chassis 120 and, thereby, relative to the other optical components of the optical system 130. The grating locating features 1427 may, for example include left and right surfaces that generally constrain left and right movement, a lower surface that generally constrains downward movement, and a rearward surface that generally constrains rearward movement. The grating locating features 1427 may generally be formed in the forward portion of the chassis 120. After being coupled to the chassis 120 (e.g., with fasteners and/or adhesive), the diffraction grating 170 remains in a fixed location and orientation relative to the chassis 120.

The chassis 120 may include hologram locating features 1428 that generally define a recess into which the hologram 180 is inserted. The recess (e.g., a second recess) is located on a second side of the chassis 120, for example, a rear side or otherwise opposite the first side of the chassis 120, and is configured to receive hologram through the second side. The hologram locating features 1428 function to locate and orient the hologram 180 relative to the chassis 120 and, thereby, relative to the other optical components of the optical system 130. The hologram locating features 1428 may, for example include upper and lower surfaces that generally constrain vertical movement, left and right surfaces that generally constrain lateral movement, and one or more forward surfaces that generally constrain forward movement. The hologram locating features 1428 may generally be formed in the rearward portion of the chassis 120. After being coupled to the chassis 120 (e.g., with fasteners and/or adhesive), the hologram 180 remains in a fixed location and orientation relative to the chassis 120.

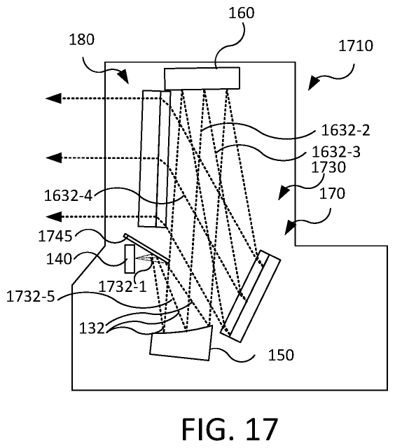

Referring to FIG. 17, a weapon sight 1710 is a variation of the weapon sight 110 and includes an optical system 1730 that is a variation of the optical system 130. The weapon sight 1710 may be configured in the manners generally described previously for the weapon sight 110, albeit with the optical system 1730 including another folding mirror 1790 that is arranged between the light source 140 and the collimator 150. In the weapon sight 1710, the folding mirror 160 may be referred to as the first folding mirror 170, while the other folding mirror 1790 may be referred to as the second folding mirror 1790.

As with the optical system 130, the optical components of the optical system 1730 are also arranged in a horizontally compact manner. A central segment 1732-1 extending along the optical path between the light source 140 and the second mirror 1745 may be generally horizontal (e.g., within 20, 15, 10 degrees or less from horizontal). A central segment 1732-5 extending along the optical path between the second mirror 1745 and the collimator 150 may be within 45, 40, 35, or 30 degrees from vertical. Furthermore, three or four of the central segments 1632-2, 1632-3, 1632-4, 1732-6, such as the central segments 1632-2, 1632-3, and 1732-5, may be within 35, 30, or 25 degrees or less from vertical, while another of the four central segments (e.g., the central segment 1632-4 between diffraction grating 170 and the hologram 180) may be within 45, 40, or 35 degrees or less from vertical.

As illustrated in FIGS. 17, the light source 140 is located generally rearward of the hologram 180 and the collimator 150 at an elevation therebetween. The second mirror 1745 is positioned forward of the light source 140 at an elevation between the hologram 180 and the collimator 150, such that a horizontal line passes through the emission area of the light source 140 and the second mirror 1745 and/or a vertical line passes through the second mirror 1730 and the hologram 180, the collimator 150, or both. The second mirror 1745 may be positioned rearward of any direct paths along which light passes from the collimator 150 and the 160, so as to not interfere therewith. Furthermore, the second mirror 1745 may function similar to the baffle 342 to prevent light emitted by the light source 140 from directly impinging on the diffraction grating 170.

The second mirror 1745 is a folding mirror having a first surface that is planar and reflective, receiving light directly from the light source 140 and reflecting the light to the collimator 150. The first surface of the second mirror 1745 may have reflectance of approximately 95%, 98%, 99%, or more (e.g., approximately 99.5%) of the light emitted by the light source 140 and incident on the first surface thereof (e.g., at the peak bandwidth at varying temperatures, or a portion of the spectral bandwidth therearound, such as the FWHM spectral width or portion thereof), for example, by having a suitable surface finish and/or reflective coating.

The collimator 150 is located generally vertically below the second mirror 1730 (as described above), as well as below the folding mirror 160 (as described above). The collimator 150 may be extend lower more than one or all the other optical components of the optical system 130 (i.e., below the light source 140, the folding mirror 160, the diffraction grating 170, and/or the hologram 180).

The first mirror 160, the diffraction grating 170, and the hologram 180 may be positioned relative to the collimator in the manners described previously for the optical system 130.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A weapon sight comprising:
a chassis that is coupleable to a firearm; and
an optical system coupled to the chassis, the optical system including:
a light source that is a light emitting diode (LED) that emits light;
a collimator that receives the light from the light source and reflects the light in parallel rays to form a collimated light beam;
a folding mirror that receives the collimated light beam from the collimator and reflects the collimated light beam;
a diffraction grating that receives the collimated light beam from the folding mirror and diffracts the light of the collimated light beam; and
a hologram that receives the light from the diffraction grating to output a holographic image of a reticle visible by a user of the weapon sight.

2. The weapon sight according to claim 1, further comprising a chassis to which which the light source, the collimator, the folding mirror, the diffraction grating, and the hologram are are coupled and located relative to each other;
wherein the LED has an emission area of approximately 100 square microns or less from which the light is emitted by the LED;
wherein the LED has a peak wavelength of between 640 nm and 660 nm, and a full width half maximum (FWHM) of approximately 40 nm or less;
wherein dispersions of the diffraction grating and the hologram compensate each other, such that the holographic image of the reticle is three MOA or less;
wherein the diffraction grating has an efficiency of 60% or more and the hologram has another efficiency of 25% or less;
wherein the collimator is an off-axis parabolic mirror and the emission area is located at a focal point of the collimator; and
wherein the light travels along four central segments of an optical path in sequence from the light source to the collimator to the folding mirror to the diffraction grating and to the hologram, wherein the four central segments are all within 45 degrees or less from vertical.

3. The weapon sight according to claim 1, wherein the LED has an emission area of approximately 500 square microns or less from which the light is emitted by the LED.

4. The weapon sight according to claim 3, wherein the emission area is approximately 100 square microns or less.

5. The weapon sight according to claim 1, wherein the LED has a peak wavelength of between 640 nm and 660 nm, and a full width half maximum (FWHM) of approximately 40 nm or less.

6. The weapon sight according to claim 1, wherein dispersions of the diffraction grating and the hologram compensate each other, such that the holographic image of the reticle is three MOA or less.

7. The weapon sight according to claim 6, wherein the diffraction grating is a volume phase reflection grating, and the hologram is a volume phase transmission hologram.

8. The weapon sight according to any of claim 6, wherein the diffraction grating has an efficiency of 60% or more and the hologram has another efficiency of 25% or less.

9. The weapon sight according to claim 1, wherein the collimator is an off-axis parabolic mirror.

10. The weapon sight according to any of claim 9, wherein the LED includes an emission area from which the light is emitted and which is located at a focal point of the collimator.

11. The weapon sight according to claim 1, wherein the light travels along four central segments of an optical path in sequence from the light source to the collimator to the folding mirror to the diffraction grating and to the hologram, wherein the four central segments are all within 45 degrees or less from vertical.

12. The weapon sight according to claim 11, wherein three of the four central segments are within 30 degrees or less from vertical.

13. The weapon sight according to claim 1, further comprising another folding mirror, wherein light travels along four central segments of an optical path in sequence the other folding mirror to the collimator to the folding mirror to the diffraction grating and to the hologram, wherein the four central segments are all within 45 degrees or less from vertical.

14. The weapon sight according to claim 1, further comprising a chassis that includes a locating features by which the light source, the collimator, the folding mirror, the diffraction grating, and the hologram are located relative to each other.

15. A weapon sight comprising:
a light source that is a light emitting diode (LED) that emits light;
a collimator that receives the light from the light source and reflects the light in parallel rays to form a collimated light beam;
a folding mirror that receives the collimated light beam from the collimator and reflects the collimated light beam;
a diffraction grating that receives the collimated light beam from the folding mirror and diffracts the light of the collimated light beam; and
a hologram that receives the light from the diffraction grating to output a holographic image of a reticle visible by a user of the weapon sight;
wherein the light travels along four central segments of an optical path in sequence from the light source to the collimator to the folding mirror to the diffraction grating and to the hologram, wherein the four central segments are all within 45 degrees or less from vertical.

16. The weapon sight according to claim 15, wherein three of the four central segments are within 30 degrees or less from vertical.

17. The weapon sight according to claim 15, further comprising another folding mirror, wherein light travels along four central segments of an optical path in sequence the other folding mirror to the collimator to the folding mirror to the diffraction grating and to the hologram, wherein the four central segments are all within 45 degrees or less from vertical.

18. A weapon sight comprising:
a chassis that is coupleable to a firearm; and
an optical system coupled to the chassis, the optical system including:
a light source that is a light emitting diode (LED) that emits light;
a collimator that receives the light from the light source and reflects the light in parallel rays to form a collimated light beam;
a folding mirror that receives the collimated light beam from the collimator and reflects the collimated light beam;
a diffraction grating that receives the collimated light beam from the folding mirror and diffracts the light of the collimated light beam; and
a hologram that receives the light from the diffraction grating to output a holographic image of a reticle visible by a user of the weapon sight;
wherein the chassis includes a locating features by which the light source, the collimator, the folding mirror, the diffraction grating, and the hologram are located relative to each other.

19. The weapon sight according to claim 18, wherein the chassis is a singular component to which at least a majority of the light source, the collimator, the folding mirror, the diffraction grating, and the hologram are directly coupled.

20. The weapon sight according to claim 19, wherein the chassis defines a first recess in a first side thereof into which the hologram is received and a second recess in a second side thereof into which the hologram is received, the second side being opposite the first side.
